(19) United States
(12) Patent Application Publication
(10) Pub. No.: US 2025/0365499 A1
(43) Pub. Date: Nov. 27, 2025

(54) ELECTRONIC DEVICE

(71) Applicant: CANON KABUSHIKI KAISHA, Tokyo (JP)

(72) Inventors: CHIAKI KAMEI, Tokyo (JP); KEISUKE INAZAWA, Tokyo (JP)

(21) Appl. No.: 19/208,701

(22) Filed: May 15, 2025

(30) Foreign Application Priority Data
May 27, 2024 (JP) 2024-085451

(51) Int. Cl. H04N 23/63; G06F 3/04845; G06F 3/0488; H04N 23/62

(52) U.S. Cl. CPC H04N 23/632; G06F 3/04845; G06F 3/0488; H04N 23/62

(57) ABSTRACT

An electronic device according to the present invention includes a processor, and a memory storing a program which, when executed by the processor, causes the electronic device to execute a control process of performing control such that a first object for executing a function in response to a touch is displayed, wherein in the control process, control is performable such that a movable second object is further displayed, in a case where the second object does not overlap the first object, an area having a first size is set as a first touch detection area for detecting a touch as a touch on the second object, and in a case where the second object overlaps the first object, an area having a second size larger than the first size is set as the first touch detection area.

### BACKGROUND OF THE INVENTION

### Field of the Invention

The present invention relates to an electronic device and particularly relates to a technique of detecting a touch on a displayed object.

### Description of the Related Art

Application software is wirelessly connected to a camera and can remotely control the camera. The application software operates on a remote terminal such as a smartphone, a tablet device, or a personal computer, and is useful when a user wants to remotely control the cameras.

In the application software, a live view image (LV image) of the camera may be acquired to display the live view image on a screen of a remote terminal. The LV image and an operation member may be displayed on one screen such that a user can operate the camera while checking the LV image. A specific object capable of movement (and enlargement and reduction) such as a feature image representing a feature of the LV image (for example, a waveform monitor (WFM) image representing a luminance distribution of the LV image) may also be displayed.

JP 2012-217101 A discloses a technique of setting a detection area for detecting a touch on an object having a high moving speed as a touch on the object to a larger area than a detection area of a stationary object.

However, in the related art, even when a user intends to touch the specific object, the touch may be detected as a touch on the LV image or the operation member such that an unintended function is executed. Even when the user intends to touch an object different from the specific object, the touch may be detected as a touch on the specific object such that an unintended function is executed.

### SUMMARY OF THE INVENTION

The present invention provides a technique capable of reducing erroneous detection of a touch on an object.

An electronic device according to the present invention includes a processor, and a memory storing a program which, when executed by the processor, causes the electronic device to execute a control process of performing control such that a first object for executing a function in response to a touch is displayed, wherein in the control process, control is performable such that a movable second object is further displayed, in a case where the second object does not overlap the first object, an area having a first size is set as a first touch detection area for detecting a touch as a touch on the second object, and in a case where the second object overlaps the first object, an area having a second size larger than the first size is set as the first touch detection area.

Further features of the present invention will become apparent from the following description of exemplary embodiments with reference to the attached drawings.

### BRIEF DESCRIPTION OF THE DRAWINGS

FIG. 1 is a schematic diagram illustrating a configuration example of a system;

FIG. 2 is a block diagram illustrating a configuration example of a camera;

FIG. 3 is a block diagram illustrating a configuration example of a smartphone;

FIG. 4 is a schematic diagram illustrating a screen example of a camera control application;

FIG. 5 is a flowchart illustrating an overall operation of a smartphone according to a first embodiment;

FIG. 6 is a schematic diagram illustrating an example of an overlapping area (WFM image); and

FIG. 7 is a flowchart illustrating an overall operation of a smartphone according to a second embodiment.

### DESCRIPTION OF THE EMBODIMENTS

### First Embodiment

Hereinafter, a first embodiment of the present invention will be described.

### System Configuration

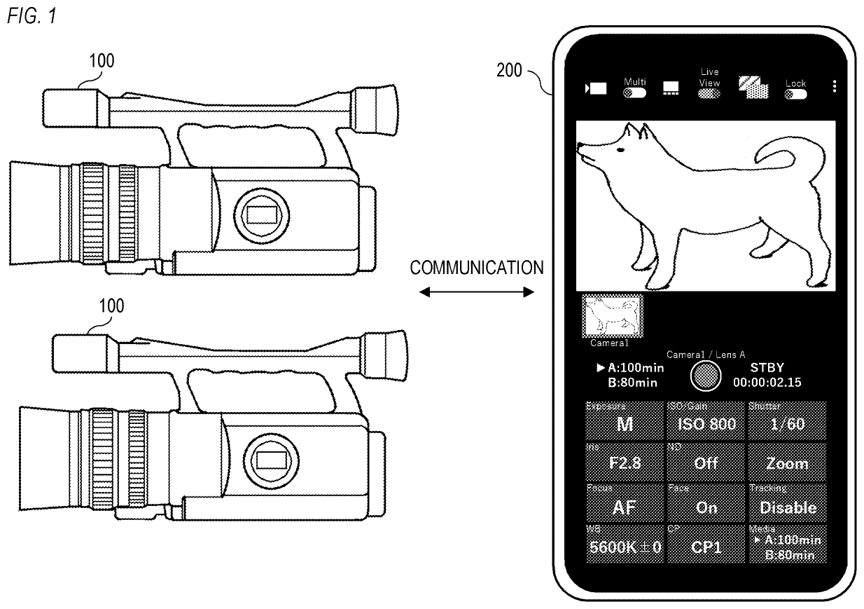

FIG. 1 is a schematic diagram illustrating a configuration example of a system according to the first embodiment. In the system of FIG. 1, a plurality of cameras 100 and a smartphone 200 are communicably connected to each other. FIG. 1 illustrates two cameras 100 but the number of the cameras 100 is not particularly limited, and one camera 100 may be connected to the smartphone 200 or three or more cameras 100 may be connected to the smartphone 200. A communication system (standard) is also not particularly limited and may be, for example, Wi-Fi (registered trademark), Bluetooth (registered trademark), or a wireless communication system exclusive to a manufacturer. The communication between the cameras 100 and the smartphone 200 may be wireless communication or wired communication. A communication system in the wired communication is also not particularly limited and may be, for example, RS-232C, RS-422A, USB, or Ethernet (registered trademark). Any communication system capable of transmitting and receiving a video and transmitting and receiving a setting value of a camera is applicable.

### Configuration of Camera

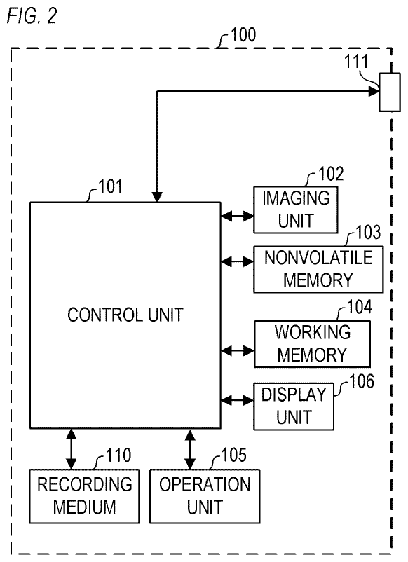

FIG. 2 is a block diagram illustrating a configuration example of the camera 100 (video camera) as an example of a data processing device according to the first embodiment. The data processing device is not limited to the camera 100. For example, the data processing device may be an electronic device such as a tablet device or a personal computer.

A control unit 101 controls each unit in the camera 100 according to an input signal or a program described below. Instead of causing the control unit 101 to control the entire camera 100, the processing may be shared by a plurality of hardware to control the entire camera 100.

An imaging unit 102 converts object light focused by a lens in the imaging unit 102 into an electrical signal, executes noise reduction processing or the like, and outputs image data that is digital data. The captured image data is accumulated in a buffer memory, is subjected to predetermined processing by the control unit 101, and is recorded in a recording medium 110.

A nonvolatile memory 103 is a nonvolatile memory that is electrically erasable and recordable, and stores a program described below to be executed by the control unit 101 or the like.

A working memory 104 is used as the buffer memory that temporarily stores the image data captured by the imaging unit 102, an image display memory of a display unit 106, a work area of the control unit 101, or the like.

An operation unit 105 is used for receiving an instruction for the camera 100 from a user. The operation unit 105 includes, for example, operation members operated by the user, such as a power button for instructing ON/OFF of a power supply of the camera 100, a release switch for instructing shooting, or a reproduction button for instructing reproduction of image data. The operation unit 105 also includes a touch panel formed in the display unit 106. The release switch includes a switch SW1 and a switch SW2. The release switch enters a so-called half-pressed state such that the switch SW1 is turned ON. As a result, an instruction for executing shooting preparations operation such as autofocus (AF) processing, autoexposure (AE) processing, auto white balance (AWB) processing, and electronic flash (EF) pre-flash processing is received. The release switch enters a so-called full-pressed state such that the switch SW2 is switched ON. As a result, the instruction for executing shooting is received.

The display unit 106 displays a live view image as a captured image showing an object substantially in real time, a shoot (recorded) captured image, text for interactive operation, and the like. The display unit 106 is not necessarily mounted on the camera 100. The camera 100 can be connected to the internal or external display unit 106 as long as the camera 100 has at least a display control function of controlling display of the display unit 106.

The recording medium 110 can store image data output from the imaging unit 102. The recording medium 110 may be attachable and detachable with respect to the camera 100 or may be mounted on the camera 100. The camera 100 only needs to have at least a function of accessing at least the recording medium 110.

A connection unit 111 is an interface for connection to an external device. The camera 100 can exchange data with the external device via the connection unit 111. The connection unit 111 includes, for example, an interface for communication with the external device via a wireless LAN. The control unit 101 implements wireless communication with the external device by controlling the connection unit 111.

The camera 100 can operate as a slave device in an infrastructure mode of a wireless LAN communication. During operation as the slave device, the camera 100 can be connected to a peripheral access point (hereinafter, AP) to participate in a network formed by the AP. The camera 100 is one type of the AP and can also operate as a simplified AP (hereinafter, simple AP) having a limited function. The AP is an example of a relay device. When the camera 100 operates as the simple AP, the camera 100 itself forms a network. A peripheral device of the camera 100 can recognize the camera 100 as the AP and participate in the network formed by the camera 100. A program for allowing the camera 100 to operate as described above is stored in the nonvolatile memory 103. The camera 100 is one type of the AP, and is a simple AP not having a gateway function of transferring data received from the slave device to an Internet service provider or the like. Accordingly, even when the camera 100 receives data from another device participating in the network formed by the camera 100 itself, the camera 100 cannot transfer the received data to a network such as the Internet. Alternatively, the connection unit 111 may be an interface of wired communication instead of wireless communication.

A communication system with the external device is not particularly limited. The connection unit 111 may be an interface for executing wired communication by a system such as RS-232C, RS-422A, USB, or Ethernet (registered trademark).

### Configuration of Smartphone

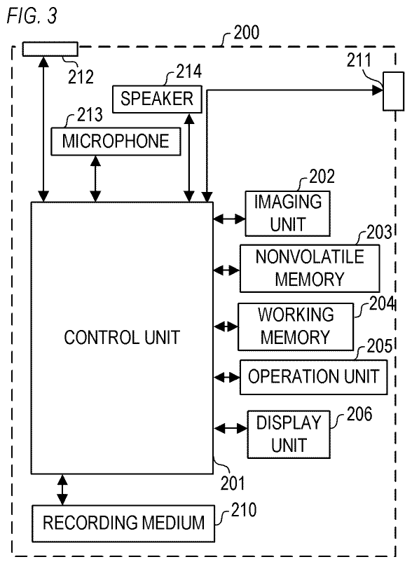

FIG. 3 is a block diagram illustrating a configuration example of the smartphone 200 as an example of a control device according to the first embodiment. The control device is not limited to the smartphone 200. For example, the control device may be an electronic device such as a digital camera, a mobile media player, a tablet device, a personal computer, or a mobile phone.

A control unit 201 controls each unit in the smartphone 200 according to an input signal or a program described below. Instead of causing the control unit 201 to control the entire smartphone 200, the processing may be shared by a plurality of hardware to control the entire smartphone 200.

An imaging unit 202 converts object light focused by a lens in the imaging unit 202 into an electrical signal, executes noise reduction processing or the like, and outputs digital data as image data. The captured image data is accumulated in a buffer memory, is subjected to predetermined processing by the control unit 201, and is recorded in a recording medium 210.

A nonvolatile memory 203 is a nonvolatile memory that is electrically erasable and recordable, and stores an operating system (OS) that is basic software to be executed by the control unit 201, various programs, and the like. A program for communication with the camera 100 is stored in the nonvolatile memory 203, and is installed as a camera control application. The processing of the smartphone 200 is implemented by reading a program of the camera control application. The camera control application has a function for using basic functions (for example, a function of a wireless LAN, a function of Bluetooth, and a function of calling another application) of the OS installed in the smartphone 200. The camera control application has a remote shooting function of remotely operating the camera 100 to shoot from the smartphone 200 while viewing the live view image obtained from the camera 100 by the smartphone 200. The camera control application has a remote reading function of remotely reading image data stored in a recording medium mounted on the camera 100 or receiving the image data. The OS of the smartphone 200 may have the functions of the first embodiment (for example, the function of the camera control application).

A working memory 204 is used as the buffer memory that temporarily stores the image data captured by the imaging unit 202, an image display memory of a display unit 206, a work area of the control unit 201, or the like.

An operation unit 205 is used for receiving an instruction for the smartphone 200 from the user. The operation unit 205 includes, for example, operation members operated by the user, such as a power button for instructing ON/OFF of a power supply of the smartphone 200 or a touch panel formed in the display unit 206.

The display unit 206 displays an image, text for interactive operation, or the like. The display unit 206 is not necessarily mounted on the smartphone 200. The smartphone 200 can be connected to the internal or external display unit 206 as long as the smartphone 200 has at least a display control function of controlling display of the display unit 206.

The recording medium 210 can store image data output from the imaging unit 202, image data received from the camera 100, or the like. The recording medium 210 may be attachable and detachable with respect to the smartphone 200 or may be mounted on the smartphone 200. The smartphone 200 only needs to have at least a function of accessing at least the recording medium 210.

A connection unit 211 is an interface for connection to an external device. The smartphone 200 can exchange data with the external device via the connection unit 211. The connection unit 211 includes, for example, an interface for communication with the external device via a wireless LAN. The control unit 201 implements wireless communication with the external device by controlling the connection unit 211.

The smartphone 200 can operate as a slave device in an infrastructure mode of a wireless LAN communication and can participate in a network formed by a peripheral AP. The camera 100 may operate as a simple AP such that the smartphone 200 participates in the network formed by the camera 100.

A public network connection unit 212 is an interface used for public wireless communication. The smartphone 200 is connected to another device via the public network connection unit 212 and can execute data communication with the other device or make a call with a user of the other device. During the call, the control unit 201 acquires a voice signal via a microphone 213 or outputs a voice signal via a speaker 214. The public network connection unit 212 includes, for example, an interface for executing communication using 3G, 4G, or 5G. The communication system is not particularly limited and may be, for example, LTE, WiMAX, ADSL, or FTTH. The connection unit 211 and the public network connection unit 212 do not need to be configured as independent hardware, and for example, one antenna may function as both of the connection unit 211 and the public network connection unit 212.

In the following description, the smartphone 200 may be described as the subject of the processing, but in practice, the control unit 201 implements various types of processing by reading and executing the programs stored in the nonvolatile memory 203. Likewise, the camera 100 may be described as the subject of the processing, but in practice, the control unit 101 implements various types of processing by reading and executing the programs stored in the nonvolatile memory 103.

### Screen Example of Smartphone

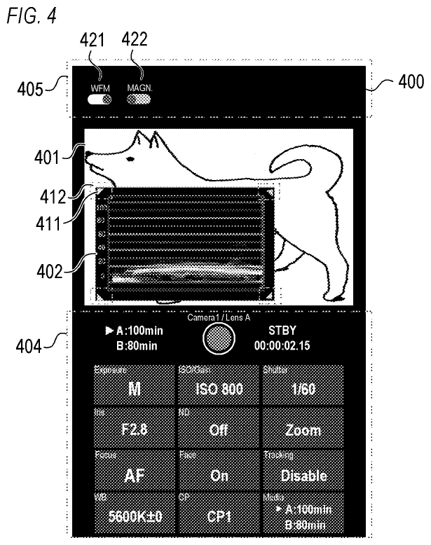

FIG. 4 is a schematic diagram illustrating a screen example of the camera control application displayed on the display unit 206 by the smartphone 200. The camera control application receives an LV image or various types of data of the camera via communication with the camera, and displays the LV image or the data on the display unit 206. The control unit 201 can execute control such that various areas (various types of information) are displayed on the screen of the camera control application. In FIG. 4, the control unit 201 is connected to the camera by the camera control application, receives the LV image and various current setting values of the camera from the camera, and displays the LV image and the setting values on a main screen 400. The display unit 206 is a display unit capable of receiving a touch operation, such as a display unit on which a touch panel is formed.

An LV area 401 is an area where the LV image acquired from a camera to be operated (hereinafter, simply referred to as the camera) is displayed. When a plurality of cameras are connected to the smartphone 200, the control unit 201 selects any of the plurality of cameras as the camera to be operated in response to a user operation or the like. When the user touches (touchdown) the LV area 401, the control unit 201 executes a function related to the camera (a function of controlling the camera). For example, the control unit 201 executes a function called touch focus. By the touch focus, an instruction to control an optical imaging system of the camera (imaging apparatus) according to a touch position such that the touch position is in focus is output to the camera. The function to be executed is not limited to the touch focus and, for example, may be a function of enlarging the LV image with the touch position as the center. The enlargement of the LV image may be digital zoom or optical zoom.

An overlapping area 402 is a quadrangular area for displaying information based on the LV image and overlaps another area. For example, in the overlapping area 402, a feature image (characteristic image) representing a feature of the LV image, for example, a waveform monitor (WFM) image representing a luminance distribution of the LV image or a histogram of luminance or color of the LV image is displayed. In the overlapping area 402, an enlarged image obtained by enlarging a part of the LV image (designated area) may be displayed. In FIG. 4, the WFM image is displayed.

In four corners of the overlapping area 402, a touch detection area 412 (area surrounded by a broken line) for detecting a touch as a touch on the overlapping area 402 (corner of the overlapping area 402) is set. When the user executes a sliding operation of touching the touch detection area 412 and moving a touch position (touchmove), the control unit 201 changes (enlarges or reduces) the size of the overlapping area 402 (WFM image). When the user executes touchup of releasing the touch, the size of the overlapping area 402 is confirmed. Hereinafter, the touch detection area 412 will be referred to as a size change touch area. In the size change touch area 412, a size change icon 411 as an item regarding size change of the overlapping area 402 is displayed.

An area obtained by excluding the size change touch area 412 from the overlapping area 402 is also a touch detection area. When the user executes a sliding operation of touching the touch detection area (area obtained by excluding the size change touch area 412 from the overlapping area 402) and moving the touch position (touchmove), the control unit 201 moves the overlapping area 402 (WFM image). Hereinafter, the touch detection area for moving the overlapping area 402 will be referred to as a moving touch area. When the user executes touchup, the position of the overlapping area 402 is confirmed.

The size change touch area 412 may be disposed in four sides of the overlapping area 402 instead of the four corners of the overlapping area 402. The size change icon 411 may be displayed only when the user touches the size change touch area 412 and not displayed during normal time. The moving touch area does not need to be the area obtained by excluding the size change touch area 412 from the overlapping area 402, and may be, for example, an upper side portion of the overlapping area 402 or a center portion of the overlapping area 402.

An operation area 404 is an area where an operation button group (operation item group) is displayed. The current setting value to be changed by an operation button may be displayed on the operation button. When the user executes a sliding operation of touching the operation area 404 and moving the touch position (touchmove), the control unit 201 scrolls the operation button group and displays the operation buttons that were not displayed in the operation area 404. Therefore, the control unit 201 does not execute the operation corresponding to the operation button in response to the touch (touchdown) on the operation button and executes the function corresponding to the operation button in response to the touchup. The function corresponding to the operation button is, for example, a function of instructing the camera to change a setting value or a function of displaying an operation panel (operation menu). The scrolling of the operation button group may not be executed. Here, the operation button group may include an operation button for executing a function in response to a touch (touchdown) or an operation button for executing a function in response to a sliding operation.

An overlapping setting area 405 is an area where a switch for switching the display of the overlapping area 402 is displayed. In FIG. 4, a WFM switch 421 and an MAGN switch 422 are displayed on the overlapping setting area 405. When the user touches the WFM switch 421, the control unit 201 switches to enable/disable the display of the WFM image. When the user touches the MAGN switch 422, the control unit 201 switches to enable/disable the display of the enlarged image. When both the WFM image and the enlarged image are not displayed, the overlapping area 402 is not shown. The WFM image and the enlarged image may be displayed on two different overlapping areas, respectively, or may be displayed on the same overlapping area. When the display of the WFM image is enabled while displaying the enlarged image, the enlarged image may be switched to not be displayed, and the WFM image may be displayed, and when the display of the enlarged image is enabled while displaying the WFM image, the WFM image may be switched to not be displayed, and the enlarged image may be displayed.

### Overall Operation of Smartphone

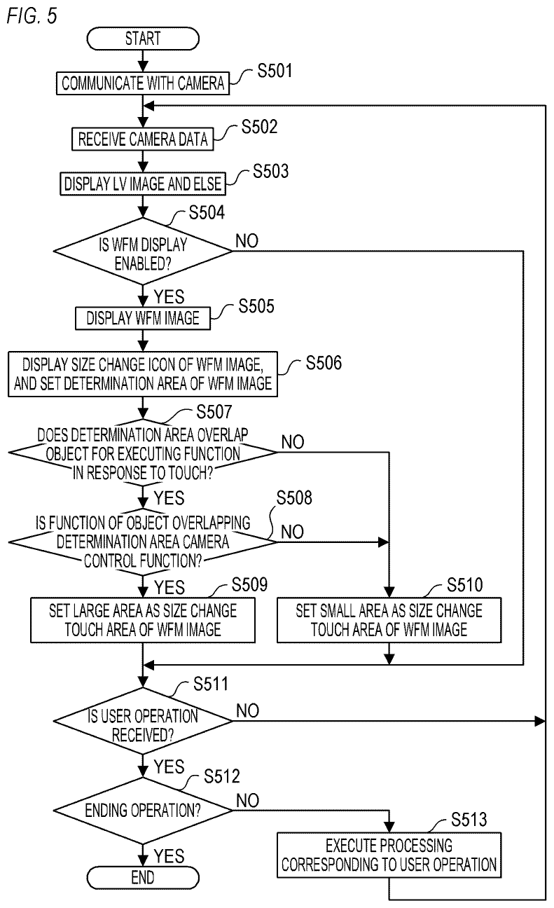

FIG. 5 is a flowchart illustrating an overall operation of the smartphone 200. The overall operation of FIG. 5 is implemented by the control unit 201 loading the program recorded in the nonvolatile memory 203 (for example, the program of the camera control application) to the working memory 204 and executing the program. For example, when start of the camera control application is instructed, the overall operation of FIG. 5 starts.

In S501, the control unit 201 executes communication with the camera 100 via the connection unit 211.

In S502, the control unit 201 receives data from the camera 100 via the connection unit 211. The data includes state, capability, setting value, LV image, and the like of the camera 100.

In S503, the control unit 201 displays the LV image, the setting button, other types of information, and the like on the display unit 206 based on the data acquired in S503. As a result, a screen such as the screen 400 of FIG. 4 is displayed.

In S504, the control unit 201 determines whether the display of the WFM image (arrangement of the overlapping area 402) is set to be enabled. When the display of the WFM image is set to be enabled, the operation proceeds to S505 and otherwise, the operation proceeds to S511.

In S505, the control unit 201 generates the WFM image based on the LV image acquired in S503, and displays the generated WFM image (superimposes the overlapping area 402 where the WFM image is displayed on another area). The control unit 201 may acquire the WFM image from the external device (for example, the camera) without generating the WFM image.

In S506, the control unit 201 displays the size change icon 411 in four corners of the WFM image (overlapping area 402). The control unit 201 sets four determination areas (predetermined areas) including four size change icons 411, respectively.

In S507, the control unit 201 determines whether the determination area overlaps an object for executing a function in response to a touch (touchdown). When the determination area overlaps the object, the operation proceeds to S508, and otherwise, the operation proceeds to S510.

In S508, the control unit 201 determines whether the object overlapping the determination area is an object for executing a camera control function (function of controlling a camera) in response to a touch. When the object is the object for executing the camera control function, the operation proceeds to S509, and otherwise, the operation proceeds to S510.

For example, when the determination area overlaps the LV image, the operation proceeds to S509, and when the determination area overlaps an operation button for displaying the operation panel, the operation proceeds to S510.

In S509, the control unit 201 sets a large size change touch area 412.

In S510, the control unit 201 sets a small size change touch area 412.

The size change touch area 412 set in S509 is larger than the size change touch area 412 set in S510. The above-described determination area may be or not be the same as the size change touch area 412 set in S510. By executing the processing of S509 and S510, the size of the size change touch area 412 changes, but the size of the moving touch area does not actively change. In response to a change in the size of the size change touch area 412, the size of the moving touch area may change.

The processing of S507 to S510 may be or not be executed for each of the four determination areas. When the processing is executed for each of the four determination areas, the large size change touch area 412 is set for the determination area satisfying the conditions of both of S507 and S508. The small size change touch area 412 is set for the determination area not satisfying the condition of at least one of S507 and S508. When a predetermined number or more of determination areas satisfy the conditions of both of S507 and S508, the size change touch area 412 larger than all of the determination areas may be set, and otherwise, the size change touch area 412 smaller than all of the determination areas may be set. The predetermined number is not particularly limited and may be one, two, three, or four.

Note that S508 may be skipped. Regardless of whether the condition of S508 is satisfied, the large size change touch area 412 may be set when the condition of S507 is satisfied, and the small size change touch area 412 may be set when the condition of S507 is not satisfied.

In S511, the control unit 201 determines whether a user operation is received. When the user operation is received, the operation proceeds to S512. Otherwise, the operation proceeds to S502.

In S512, the control unit 201 determines whether the user operation received in S511 is an application ending operation. When the user operation is the application ending operation, the overall operation of FIG. 5 ends, and otherwise, the operation proceeds to S513.

In S513, the control unit 201 executes processing corresponding to the user operation received in S511.

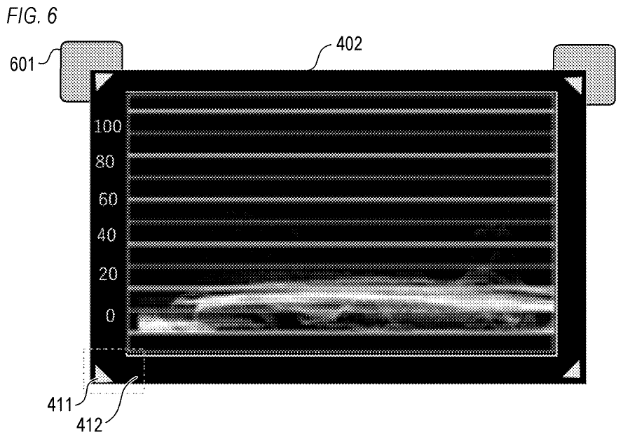

FIG. 6 is a schematic diagram illustrating an example of the overlapping area 402 (WFM image). In FIG. 6, the large size change touch area 412 is set for the upper left corner and the upper right corner of the overlapping area 402 by S509 of FIG. 5, and the small size change touch area 412 is set for the lower left corner and the lower right corner of the overlapping area 402 by S510. As illustrated in FIG. 6, the large size change touch area 412 may be displayed to be identifiable by color, luminance, pattern, mask, frame, or the like. As a result, the user can easily grasp that the size of the size change touch area 412 is changed. The large size change touch area 412 may also be displayed to be identifiable.

As described above, according to the first embodiment, the size of the touch detection area (size change touch area) for detecting a touch as a touch on the specific object (movable object) changes. When the specific object (determination area) overlaps an object for executing a function in response to a touch (touchdown), a larger area than that when the specific object is not such an object is set as the touch detection area of the specific object. As a result, erroneous detection of a touch on an object can be reduced. For example, by setting a large area as the touch detection area of the specific object, it is possible to prevent a phenomenon that “the user intends to touch an object different from a specific object but the touch is detected as a touch on the specific object such that an unintended function is executed”. In the first embodiment, a large area is not always set as the touch detection area of the specific object. Therefore, it is also possible to prevent a phenomenon that “the user intends to touch an object different from a movable object but the touch is detected as a touch on the specific object such that an unintended function is executed”.

In the first embodiment, even when the specific object overlaps an object for executing a function in response to a touch (touchdown), unless the function of the object is the camera control function, a small area is set as the touch detection area of the specific object. As a result, a decrease in operability caused by the enlargement of the touch detection area of the specific object can be prevented while preventing the unintended execution of the camera control function. For example, the enlargement of the touch detection area of the specific object by which a detection area of an icon for executing a specific function other than the camera control function in response to a touch (touchdown) is reduced can be prevented. A decrease in the operability of the icon caused by the reduction in the touch detection area of the icon can be prevented.

The movable object, the determination area, and the size change touch area are not limited to the above-described configuration. For example, the movable object may be an icon, the determination area may be the entire area of an icon, or the size change touch area may be an area including the entire icon.

### Second Embodiment

Hereinafter, a second embodiment of the present invention will be described. The description of the same portions as those of the first embodiment will not be repeated.

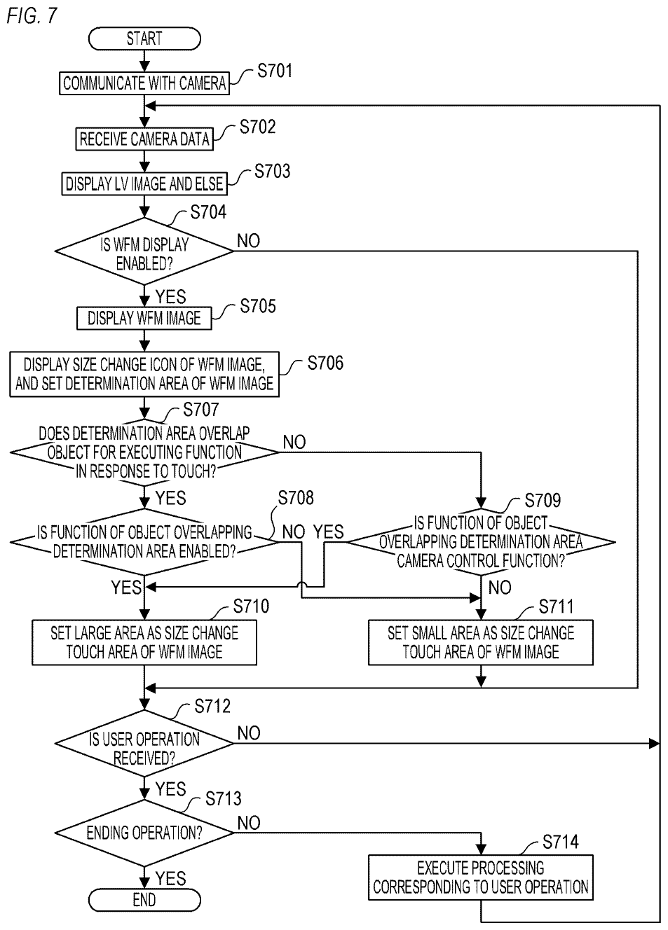

FIG. 7 is a flowchart illustrating an overall operation of the smartphone 200 according to the second embodiment. The overall operation of FIG. 7 is implemented by the control unit 201 loading the program recorded in the nonvolatile memory 203 (for example, the program of the camera control application) on the working memory 204 and executing the program. For example, when start of the camera control application is instructed, the overall operation of FIG. 7 starts.

S701 to S706 are the same as S501 to S506 of FIG. 5.

In S707, as in S507, the control unit 201 determines whether the determination area overlaps an object for executing a function in response to a touch (touchdown). When the determination area overlaps the object, the operation proceeds to S708, and otherwise, the operation proceeds to S709.

In S708, the control unit 201 determines whether the function (function to be executed in response to a touch) of the object overlapping the determination area is enabled. When the function is enabled, the operation proceeds to S710, and otherwise, the operation proceeds to S711.

In S709, the control unit 201 determines whether the object overlapping the determination area is an object for executing a camera control function (function of controlling a camera) in response to a user operation other than a touch (touchdown). When the object is the object for executing the camera control function, the operation proceeds to S710, and otherwise, the operation proceeds to S711.

At least one of S708 and S709 may be skipped. For example, S708 may be skipped, and when the determination area overlaps the object for executing a function in response to a touch (touchdown), the operation may proceed from S707 to S710. S709 may be skipped, and when the determination area does not overlap the object for executing a function in response to a touch (touchdown), the operation may proceed from S707 to S711.

S710 to S714 are the same as S509 to S513 of FIG. 5.

As described above, in the second embodiment, a method of setting the touch detection area (size change touch area) of the specific object is different from that of the first embodiment. In the second embodiment, even when the specific object (determination area) overlaps an object for executing the camera control function in response to a user operation other than a touch (touchdown), a large area is set as the touch detection area of the specific object. As a result, the unintended execution of the camera control function can be further prevented. For example, the camera control function in response to a touch (touchdown) can be prevented from being executed against the user's intention, and the camera control function in response to another user operation can also be prevented from being executed against the user's intention.

In the second embodiment, when the function of the object overlapping the specific object (determination area) is disabled, the touch detection area of the specific object is not enlarged, and a small area is set as the touch detection area of the specific object. As a result, the unnecessary enlargement of the touch detection area of the specific object can be prevented, and a processing load can be reduced.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, erroneous detection of a touch on an object can be reduced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-085451, filed on May 27, 2024, which is hereby incorporated by reference herein in its entirety.

What is claimed is:

1. An electronic device comprising:
a processor; and
a memory storing a program which, when executed by the processor, causes the electronic device to execute a control process of performing control such that a first object for executing a function in response to a touch is displayed, wherein
in the control process,
control is performable such that a movable second object is further displayed,
in a case where the second object does not overlap the first object, an area having a first size is set as a first touch detection area for detecting a touch as a touch on the second object, and
in a case where the second object overlaps the first object, an area having a second size larger than the first size is set as the first touch detection area.

2. The electronic device according to claim 1, wherein
in the control process,
control is performed such that a captured image as the first object and an item for displaying an operation panel are displayed,
in a case where the second object overlaps the item, an area having the first size is set as the first touch detection area, and
in a case where the second object overlaps the captured image, an area having the second size is set as the first touch detection area.

3. The electronic device according to claim 1, wherein
the first object includes a captured image acquired from an imaging apparatus, and
in the control process, in a case where the captured image is touched, an instruction to control an optical imaging system of the imaging apparatus according to a position of the touch is output.

4. The electronic device according to claim 1, wherein
the first object includes a captured image, and
the second object includes a feature image representing a feature of the captured image.

5. The electronic device according to claim 1, wherein
in the control process, control is performed such that the second object is moved according to a touch operation of touching a second touch detection area set for the second object and moving a touch position.

6. The electronic device according to claim 5, wherein
in the control process, a size of the first touch detection area changes, and a size of the second touch detection area does not change.

7. The electronic device according to claim 1, wherein
in the control process,
in a case where a predetermined area of the second object does not overlap the first object, an area including the predetermined area and having the first size is set as the first touch detection area, and
in a case where the predetermined area overlaps the first object, an area including the predetermined area and having the second size is set as the first touch detection area.

8. The electronic device according to claim 7, wherein
the predetermined area is a same area as the first touch detection area having the first size.

9. The electronic device according to claim 7, wherein
the second object is a quadrangular object, and
in the control process, four first touch detection areas respectively corresponding to four predetermined areas disposed in four corners of the second object or four sides of the second object are set.

10. The electronic device according to claim 9, wherein
in the control process, a size of the second object changes according to a touch operation of touching the first touch detection area and moving a touch position.

11. The electronic device according to claim 10, wherein
in the control process, control is performed such that an item regarding a size change of the second object is displayed in response to a touch on the first touch detection area.

12. The electronic device according to claim 7, wherein
in the control process,
a plurality of first touch detection areas respectively corresponding to a plurality of predetermined areas of the second object are set,
for a predetermined area that does not overlap the first object among the plurality of predetermined areas, a first touch detection area including the predetermined area and having the first size is set, and
for a predetermined area that overlaps the first object among the plurality of predetermined areas, a first touch detection area including the predetermined area and having the second size is set.

13. The electronic device according to claim 1, wherein
in the control process, even if the second object overlaps the first object, in a case where a function to be executed in response to a touch on the first object is not a function of controlling an imaging apparatus, an area having the first size is set as the first touch detection area.

14. The electronic device according to claim 1, wherein
in the control process,
control is performed such that a third object for executing a function in response to a user operation is further displayed, and
in a case where the second object overlaps the third object, an area having the first size is set as the first touch detection area.

15. The electronic device according to claim 14, wherein
in the control process, even if the second object overlaps the third object, in a case where a function to be executed in response to a user operation on the third object is a function of controlling an imaging apparatus, an area having the second size is set as the first touch detection area.

16. The electronic device according to claim 1, wherein
in the control process, even if the second object overlaps the first object, in a case where a function to be executed in response to a touch on the first object is disabled, an area having the first size is set as the first touch detection area.

17. The electronic device according to claim 1, wherein
in the control process, in a case where the first touch detection area having the second size is set, control is performed such that the first touch detection area is identifiable.

18. A control method of an electronic device, comprising:
performing control such that a first object for executing a function in response to a touch is displayed;
performing control such that a movable second object is displayed;
setting an area having a first size as a first touch detection area for detecting a touch as a touch on the second object, in a case where the second object does not overlap the first object; and
setting an area having a second size larger than the first size as the first touch detection area, in a case where the second object overlaps the first object.

19. A non-transitory computer readable medium that stores a program, wherein the program causes a computer to execute a control method of an electronic device, the control method comprising:
performing control such that a first object for executing a function in response to a touch is displayed;
performing control such that a movable second object is displayed;
setting an area having a first size as a first touch detection area for detecting a touch as a touch on the second object, in a case where the second object does not overlap the first object; and
setting an area having a second size larger than the first size as the first touch detection area, in a case where the second object overlaps the first object.
